(19) United States
(12) Patent Application Publication
(10) Pub. No.: US 2010/0260363 A1
(43) Pub. Date: Oct. 14, 2010

(54) MIDI-COMPATIBLE HEARING DEVICE AND REPRODUCTION OF SPEECH SOUND IN A HEARING DEVICE

(75) Inventors: Raoul Glatt, Zurich (CH); Hilmar Meier, Zurich (CH)

Correspondence Address: PEARNE & GORDON LLP, 1801 EAST 9TH STREET, SUITE 1200, CLEVELAND, OH, 44114-3108, US

(73) Assignee: Phonak AG, Staefa (CH)

(21) Appl. No.: 12/758,921

(22) Filed: Apr. 13, 2010

Related U.S. Application Data
(63) Continuation-in-part of application No. 12/269,985, filed on Nov. 13, 2008, now Pat. No. 7,705,232.
Application No. 12/269,985 is a continuation of application No. 11/248,045, filed on Oct. 12, 2005, now Pat. No. 7,465,867.

(51) Int. Cl. H04R 25/00

(52) U.S. Cl. 381/312

(57) ABSTRACT

The method for providing a user of a hearing device with speech sound comprises the step of
a) providing in the hearing device speech-representing data representative of speech-bound contents.

The speech-bound contents is encoded in said speech-representing data in a compressed way by means of a set of encoded-speech-segment data, wherein each of the encoded-speech-segment data of the set is indicative of one speech segment, and wherein the speech-representing data comprise a multitude of the encoded-speech-segment data.

And it also comprises the steps of
b) deriving from the multitude of the encoded-speech-segment data audio signals representative of the speech-bound contents by composing audio signal segments derived by decoding the multitude of encoded-speech-segment data; and
c) converting the so-derived audio signals into speech sound by means of an output converter of the hearing device.

Preferably, the encoded-speech-segment data are MIDI data, wherein MIDI stands for Musical Instrument Digital Interface. For example, the speech-bound contents is the contents of an audio book or news to which the user wants to listen.

### TECHNICAL FIELD

The invention relates to the field of hearing devices. The hearing device can be a hearing aid, worn in or near the ear or (partially) implanted, a headphone, an earphone, a hearing protection device, a communication device or the like. The invention relates furthermore to methods of operating a hearing device and to the use of MIDI—i.e., Musical Instrument Digital Interface—compliant data in a hearing device.

### STATE OF THE ART

Today, many hearing devices, e.g., hearing aids, are capable of generating some simple acoustic acknowledge signals, e.g., a beep or double-beep signalling that a first or a second hearing program has been chosen by the user of the hearing device.

In WO 01/30127 A2 a hearing aid is disclosed, which allows to feed user-defined audio-signals into the hearing device, which user-defined audio-signals can then be used as acknowledge signals.

U.S. Pat. No. 6,816,599 discloses an ear-level electronic device within a hearing aid, capable of generating electrical signals representing music. By means of a pseudo-random generator extremely long sequences of music can be created which can produce a sensation of relief to persons suffering tinnitus.

In the world of electronic music, where music synthesizers, electronic keyboards, drum machines and the like are used, the Musical Instrument Digital Interface (MIDI) protocol has been introduced in 1983 by the MIDI Manufacturers Association (MMA) as a new standard for digitally representing musical performance information. A number of specifications of MIDI-related data formats have been issued by the MMA within the last 10 to 20 years. Within the last couple of years, MIDI-compliant data (MIDI data) have found application in mobile phones, where MIDI data, in particular data compliant with the Scalable Polyphony MIDI (SP-MIDI) specification, introduced in February 2002, are used for defining telephone ring tones.

In U.S. Pat. No. 5,915,237, it is described how MIDI can be used for representing speech.

### DEFINITION

Under audio signals we understand electrical signals, analogue and/or digital, which represent sound.

### SUMMARY OF THE INVENTION

One object of the invention is to create a hearing device that provides for an alternative way of defining sound information to be perceived by a user of the hearing device.

Another object of the invention is to provide for a hearing device with an enhanced compatibility to other equipment.

Another object of the invention is to provide for a hearing device which can easily be individualized and adapted to a user's taste and preferences.

Another object of the invention is to provide a way for providing a hearing device user with speech sound by means of the hearing device, in particular in a way taking into account the limited resources available in a hearing device.

At least one of these objects is at least partially achieved by a hearing device according to the patent claims.

In addition, the respective method for operating a hearing device shall be provided, as claimed in the patent claims.

The hearing device according to the invention is MIDI compatible, i.e., Musical Instrument Digital Interface compatible.

MIDI specifications are defined by the MIDI Manufacturers Association (MMA). In 1983 the Musical Instrument Digital Interface (MIDI) protocol was introduced by the MMA.

In the MMA various companies from the fields of electronic music and music production are joined together to create MIDI standards and specifications assuring compatibility among MIDI-compatible products. Since 1985 the MMA has issued about 11 new specifications and adopted about 38 sets of enhancements to MIDI.

Unlike MP3, WAV, AIFF and other digital audio formats, MIDI data do not (or at least not only) contain recorded sound or recorded music. Instead, music is described in a set of instructions (parameters) to a sound generator, like a music synthesizer. Therefore, playing music via MIDI (i.e., using MIDI data) implies the presence of a MIDI-compatible sound generator or synthesizer. MIDI data usually comprise messages, which can instruct the synthesizer, which notes to play, how loud to play each note, which sounds to use, and the like. This way, MIDI files can usually be very much smaller than recorded digital audio files.

The current MIDI specification is MIDI 1.0, v96.1 (second edition). It is available in form of a book: ISBN 0-9728831-0-X. Originally, the MIDI specification defined a physical connector and, in what can be referred to as the MIDI Message Specification, also named MIDI protocol, a message format, i.e., a format of MIDI messages. Some years later, a file format (storage format) called Standard MIDI File (SMF) was added. An SMF file contains MIDI messages (i.e., data compliant with the MIDI protocol), to which a time stamp is added, in order to allow for a playback in a properly timed sequence.

MIDI specifications or MIDI-related specifications (companion specifications), issued by the MMA, of (potential) interest for the invention comprise at least the following ones:
the MIDI protocol defining MIDI messages (see above);
the Standard MIDI file format (SMF), see above;
the MIDI Machine Control specification (MMC), meant for controlling machines like mixing consoles or other audio recording equipment;
the MIDI Show Control specification (MSC), meant for controlling lamps and machines like smoke machines;
the MIDI Time Code specification (MTC), for synchronizing MIDI equipment;
the General MIDI Specifications (GM/GM 1, GM 2, GM Lite), defining several minimum requirements (e.g., on polyphony) and allocation of standard sounds, in order to assure some standard performance compatibility among MIDI instruments so as achieve similarly sounding results when using different platforms;
the Scalable Polyphony MIDI specification (SP-MIDI, issued February 2002, corrected November 2001), which defines MIDI messages allowing a sound generator to play, in a well-defined way, music that usually would require a higher polyphony (i.e., a higher number of simultaneously generatable sounds) than the sound generator is capable of producing; in other words, depending on the available polyphony of the sound generator, tones are played and not played, in a well-defined way;
a file format called DownLoadable Sounds Format (DLS Level 1, DLS-1, version 1.1b issued September 2004, DLS Level 2, DLS-2, version 2.1, amended November 2004), which defines a way of providing sounds (samples, WAV files) and articulation parameters for the sounds, so that at least a part of the notes of a MIDI song can be heard with original sounds instead of with sounds given by the sound generator, which are often not very close to the original;
a file format called eXtensible Music Format (XMF), version 2.0 issued in December 2004, which defines a standard for gathering in one single file a number of different data (e.g., SMF files and DLS data) required to assure a consistent audio playback of MIDI note-based information on various platforms;
the SMF w/DLS File Format Specification (February 2000) defining a file format for bundling an SMF file with DLS data, known as RMID file format, which is outdated today and, since November 2001, recommended to be replaced by the XMF file format (see above);
the DLS format for mobile devices (MDLS) issued September 2004, based on DLS-2;
the Mobile XMF specification, version 2.0 issued September 2004 together with MDLS; and
the Standard MIDI File (SMF) Lyrics Specification (SMF Lyric Meta Event Definition), issued January 1998, which defines a recommended way of implementing lyrics in SMF files.

MIDI specifications, definitions, recommendations and further information about MIDI can be obtained from the MMA, in particular from via the internet at http://www.midi.org.

Through providing the hearing device with MIDI compatibility, a new way of defining sound in a the hearing device is provided, in particular a new way of defining sound information to be perceived by a user of the hearing device. The hearing device is provided with an enhanced compatibilty to other equipment, in particular other MIDI compatible equipment. The hearing device can easily be individualized and adapted to the user's taste and preferences. A well-tested and efficient way of representing sound is implemented into the hearing device, which can be advantageous, in particular when the sound is complex, e.g., due to polyphony or length and number of notes to be played, respectively.

The term MIDI data shall, at least within the present patent application, be understood as data compliant with at least one MIDI specification (or MIDI-related specification), in particular with one of those listed above.

More specifically, the term MIDI data can be interpreted as data compliant with the (current) MIDI protocol, i.e., MIDI messages (including data of SMF files).

The hearing device according to the invention can be adapted to comprising MIDI data.

The hearing device can be adapted to
communicating and/or
loading and/or
storing and/or
interpreting and/or
generating:
data compliant with the MIDI Protocol (messages compliant with the MIDI Message Specification; MIDI messages), and/or
Standard MIDI Files, and/or
files in the eXtensible Music Format, and/or
Mobile XMF files, and/or
data compliant with the SP-MIDI specification, and/or
DLS data, i.e., data compliant with the DownLoadable Sounds Format, and/or
Mobile DLS data, and/or
MMC data, and/or
MSC data, and/or
MTC data, and/or
General MIDI data, and/or
RMID files, and/or
files compliant with the SMF Lyric Meta Event Definition.

The hearing device can comprise a MIDI interface. The MIDI interface allows for a simple communication of MIDI data with other devices.

The hearing device can comprise a sound generator adapted to interpreting MIDI data. An efficient control of the sound generation can thus be achieved, which, in addition, is compatible with a wide range of other sound generators.

The hearing device can comprise a unit for interpreting MIDI data. That unit may be realized in form of a processor or a controller or in form of software. MIDI data can be transformed into other information, e.g., information to be given to a sound generator within the hearing device so as to have a desired sound or piece of music played.

One way of using MIDI data in a hearing device is in conjunction with the generation of sound to be perceived by the hearing device user. E.g., acknowledge sounds, also called feedback sounds, which are played to the user upon a change in the hearing device's function, e.g., when the user changes the loudness (volume) or another setting or program, or when some other user's manipulation shall be acknowledged, or when the hearing device by itself takes an action, e.g., by making a change, e.g., if, in the case of a hearing aid, the hearing aid chooses, in dependence of the acoustical environment, a different hearing program (frequency-volume settings and the like), or when the hearing device user shall be informed that a hearing device's battery is low.

It is also possible to use MIDI in a hearing device in conjunction with musical signals to be played to the user of the hearing aid. And it is also possible to use MIDI in a hearing device in conjunction with guiding signals, which help to guide the user, e.g., during a fitting procedure, during which the hearing device is adapted to the user's hearing preferences.

Furthermore, according to today's trend to individualization, it is possible to personalize a hearing device by aid of MIDI. E.g., said acknowledge sounds could be loaded into the hearing device in form of MIDI data. From the hearing device manufacturer or from a third party, the hearing device user could receive, possibly against payment, MIDI data for such sounds, chosen according to the user's taste.

It is possible to load such MIDI data to the hearing device, which define the sound to be played to the hearing device user when the user's (possibly mobile) telephone rings. And even, a number of ring sounds can be loaded into the hearing device, wherein the sound to be played to the hearing device user when the user's telephone rings, is chosen in dependence of the person who calls the hearing device user, or, more precisely, depending on the telephone number of the telephone apparatus from which the hearing device user is called.

This may be accomplished, e.g., by either sending MIDI data to the hearing device upon an incoming call in the telephone, or by having MIDI data stored in the hearing device, which describe ring tones, and upon an incoming call in the telephone, the hearing device receives not the actual MIDI data, but a link instructing the hearing device, which of the MIDI-based ring tones stored in the hearing device to play to the hearing device user.

In addition, it is possible to use MIDI data in a hearing device in conjunction with speech synthesis. E.g., speech signals stored in the hearing device could be addressed or controlled by MIDI data. Or speech signals, be it synthesized or sampled, could be encoded in MIDI, e.g., using the DownLoadable Sounds Format (DLS) of MIDI.

As to the use of speech in hearing devices and hearing systems, MIDI data provide a good way for taking the limited size of hearing devices into account: Due to the limited size, the storage space in a hearing device is very limited, and so is the power for data transmission into and out of the hearing device which makes it desirable to transmit data in a compressed way. Besides using MIDI for encoding speech-related data, also other ways of encoding speech-bound contents can be used. The methods and hearing devices presented in the following address specific speech-related aspects.

The method for providing a user of a hearing device with speech sound comprises the steps of
a) providing in said hearing device speech-representing data representative of speech-bound contents, which speech-bound contents are encoded in said speech-representing data in a compressed way by means of a set of encoded-speech-segment data, each of said encoded-speech-segment data of said set being indicative of one speech segment, said speech-representing data comprising a multitude of said encoded-speech-segment data;
b) deriving from said multitude of said encoded-speech-segment data audio signals representative of said speech-bound contents by composing audio signal segments derived by decoding said multitude of encoded-speech-segment data; and
c) converting the so-derived audio signals into speech sound by means of an output converter of said hearing device.

This way, it is possible to provide that the hearing device needs to handle very space-saving data and therefore relatively little data only, be it with respect to storing the data, to receiving the data, to transmitting the data or to some kind of processing the data. It is to be noted that the addressed speech-representing data are usually compressed to a far greater extent than, e.g., compressed audio signals such as audio signals compressed using the well-known MP3 algorithm or a similar audio data compression algorithm.

In one embodiment, said speech is composable from said speech segments.

In one embodiment, said speech denotes the human speech, speech being a human language, wherein speech can be generated, besides the natural way of a human being speaking, by artificially synthesizing it, e.g., from artificial sounds, or by replaying recorded sound or otherwise.

In one embodiment, each one of said speech segments is, e.g., a letter, a syllable, a phoneme, a word, or a sentence.

In one embodiment, each one of said encoded-speech-segment data encodes a letter, a syllable, a phoneme, a word, or a sentence.

In one embodiment, said speech-representing data are digital data.

In one embodiment, said set of encoded-speech-segment data is a pre-defined set of encoded-speech-segment data.

In one embodiment, said set of encoded-speech-segment data is a pre-defined set of a pre-defined number of encoded-speech-segment data.

In one embodiment, said set of encoded-speech-segment data is a pre-defined set of a limited number of encoded-speech-segment data.

In one embodiment, said hearing device is a device, which is worn in or adjacent to an individual's ear with the object to improve the individual's audiological perception, wherein such improvement may also be barring acoustic signals from being perceived in the sense of hearing protection for the individual.

In a particular view at the invention, we define:

“A hearing device” is a device, which is worn in or adjacent to an individual's ear with the object to improve the individual's audiological perception. Such improvement may also be barring acoustic signals from being perceived in the sense of hearing protection for the individual. If the hearing device is tailored so as to improve the perception of a hearing impaired individual towards hearing perception of a normal-hearing individual, then we speak of “a hearing-aid device”. With respect to the application area, a hearing device may be applied, e.g., behind the ear, in the ear, completely in the ear canal or may be implanted. In further definition, “a hearing system” comprises at least one hearing device; in case that a hearing system comprises at least one additional device, all devices of the hearing system are operationally connectable within the hearing system. Typically, said additional devices such as another hearing device, a remote control or a remote microphone, are meant to be worn or carried by said individual.

In one embodiment, the method comprises, before step a), the step of
r) receiving in said hearing device said speech-representing data.

In one embodiment, the method comprises, before step r), the steps of
d) generating said speech-representing data in a device different from said hearing device; and
e) transmitting said speech-representing data from said device to said hearing device.

Said device can be, e.g., a device of a hearing system to which the hearing device belongs or a device external to the hearing system. E.g., a charging device, an interface device such as a bluetooth interface device or an other interface device operationally connected to the hearing device, a remote control, a computer, an MP3 player, each having the additional functionality of generating said speech-representing data.

In one embodiment, said encoded-speech-segment data are MIDI data. For example, in U.S. Pat. No. 5,915,237 by Boss et al., a way for encoding speech in MIDI data is described. The teachings of U.S. Pat. No. 5,915,237 are herewith incorporated by reference in the present patent application.

In one embodiment, step b) comprises the steps of
b1) deriving, for each of said encoded-speech-segment data of said multitude of said encoded-speech-segment data, an audio signal segment representative of the respective speech segment;
b2) deriving audio signals representative of said speech-bound contents by composing the so-derived audio signal segments.

In one embodiment, said method is a method for speech training or for speech intelligibility training or for speech testing or for speech intelligibility testing.

In one embodiment, said speech-representing data are representative of speech examples/speech samples or of speech-like examples or samples for use in speech training or speech intelligibility training or speech testing or speech intelligibility testing.

In one embodiment, the method comprises the step of
f) prompting said user for a reply in reaction to perceiving said speech sound outputted in step c).

For example, the user has to repeat a sentence he has heard perceiving the speech sound mentioned in step c), or he has to operate a specific user control, e.g., a user control of the hearing device, of an accessory such as a remote control or of another device belonging to or external to a hearing system to which the hearing device belongs. The user's speech intelligibility and/or the user's speaking skills can then be judged from analyzing the user's response (such as a spoken sentence).

In one embodiment, the method comprises the steps of
g) receiving a reply from said user in reply to said prompting mentioned in step f);
h) evaluating said reply; and
i) taking an action in dependence of a result of said evaluation.

In one embodiment, step i) is carried out automatically by said hearing device. E.g., the sound example is replayed, or a next sound example is played. Or the user's skills are assessed from said reply, e.g., evaluating the user's speaking skills from the intelligibility of the user's reply; or the user's speech intelligibility (speech understanding ability) is evaluated from a user's answer to a question.

In one embodiment, said speech-bound contents is help information for said user or instructions for said user. In particular, said help information is help information for said user concerning the operation of a device of a hearing system to which the hearing device belongs or even more particularly help information for said user concerning the operation of the hearing device; and/or in particular, said instructions are instructions for said user concerning the operation of a device of a hearing system to which the hearing device belongs or even more particularly instructions for said user concerning the operation of the hearing device.

E.g., it is possible to provide that step c) and/or step b) is carried out upon a request by said user; e.g., a push button or toggle switch such as the one used for selecting different hearing programs, can be used for initiating the playback of stored help texts. It is further possible to provide the possibility to navigate forward and backward in the help text so as to reach the desired section of the help text, e.g., by means of a toggle switch.

In one embodiment, step c) is carried out upon a request by said user.

In one embodiment, step b) is carried out upon a request by said user.

In one embodiment, said speech-bound contents is or comprises information about one or more upcoming calendar events. This way, the user can be informed right in time or suitably in advance to take a scheduled action. The user can receive reminders of calendar events. E.g., in the above-described way of using compressed speech-representing data, the user is informed about meetings, birthdays, appointments, medicine to be taken or the like. This works particularly well when the hearing device is operationally connected or connectable to a scheduling system such as a PDA (personal digital assistant), a computer with a scheduling software or a smart phone or the like. It is possible to enable a synchronization between the hearing device or a hearing system to which the hearing device belongs with such a scheduling system, e.g., in the well-known way used when synchronizing, e.g., a PDA with a computer.

In one embodiment with said upcoming calendar events, the method comprises, before step a), the step of
r) receiving in said hearing device said speech-representing data.

Typically, there are times associated with said upcoming calendar events, usually one or at least one time for each calendar event. The corresponding data indicating the respective time or times are referred to as time-indicative data. The time-indicative data are indicative of one or more times associated with a respective upcoming calendar event, typically the time at which the respective calendar event takes place or is due. Time-indicative data can facilitate producing a speech-based reminder at the appropriate time. The latter can be facilitated by the provision of a timer or a clock in the hearing device or in a hearing system to which the hearing device belongs.

In one embodiment with said upcoming calendar events, the time at which said conversion mentioned in step c) is carried out depends on such time-indicative data. In particular, the time at which said conversion mentioned in step c) is carried out is determined by said time-indicative data.

In one embodiment with said upcoming calendar events, said steps a), b) and c) are carried out upon step r). This implements the described calendar reminder functionality in a “live-stream” type of way. In this case, step r) is usually carried out at a pre-defined time interval before or just before a time indicated by said time-indicative data or at said time indicated in said time-indicative data. This “live stream” type implementation can render the provision of a timer or clock in the hearing device for the calendar reminder functionality superfluous, since the device or apparatus sending said speech-representing data basically determines the time at which the user perceives a calendar reminder.

In another embodiment with said upcoming calendar events, the method comprises the step of
s) receiving in said hearing device time-indicative data associated with said one or more upcoming calendar events encoded in said speech-representing data;
   and said step r) (and usually also step s)) is accomplished at a time before a time indicated by said time-indicative data and otherwise independent of said time indicated in said time-indicative data. This implements the described calendar reminder functionality in a “offline” type of way. The reception of said speech-representing data in said hearing device is independent of a time indicated in said time-indicative data (except that the reception takes place before the time associated with the calendar event). I.e. at some time, e.g., determined by the user or automatically (initiated by the hearing device or by the device or apparatus sending the speech-representing data), said speech-representing data are received in said hearing device, usually together with the above-described time-indicative data. This can happen, e.g., about half a day or a day in advance, or more than one day in advance. At an appropriate time given by the respective time-indicative data, steps b) and c) are carried out for the respective calendar event.

In one embodiment, the method comprises, before step a), the step of
r) receiving in said hearing device said speech-representing data;
   wherein step r) is carried out upon a request by said user.

In one embodiment, said speech-bound contents is contents of an audio book.

In one embodiment, said speech-bound contents is news.

In one embodiment, said speech-bound contents is contents of a blog.

Also in these cases, it is possible to accomplish a “live stream”-like mode, wherein the method comprises, before step a) the step of
r) receiving in said hearing device said speech-representing data;
   and wherein steps a), b) and c) are carried out upon step r). And in particular, wherein step r) is carried out upon a request by said user.

It is also possible to accomplish an “offline”-type of mode, wherein the time at which said conversion mentioned in step c) is carried out is not determined by said speech-bound contents, in particular is independent of said speech-bound contents.

In one embodiment, said hearing device is at least one of a hearing aid and a hearing protection device.

Quite generally, there are, among others, comprised in conjunction with speech sound reproduction in a hearing device:
embodiments, in which said speech-bound contents is contents merely to be perceived by said user and does not aim at provoking any action by said user related to said hearing device;
embodiments, in which said speech-bound contents is unrelated to said hearing device and unrelated to hearing and unrelated to speech;
embodiments, in which step r) is carried out upon a request by said user;
embodiments, in which the time at which said reception mentioned in step r) is accomplished is independent of (and not determined by) said speech-bound contents;
embodiments, in which step c) is carried out upon a request by said user;
embodiments, in which the time at which said conversion mentioned in step c) is carried out is independent of (and not determined by) said speech-bound contents;
embodiments, in which step b) is carried out upon a request by said user;
embodiments, in which the time at which said deriving mentioned in step b) is carried out is independent of (and not determined by) said speech-bound contents.

The hearing device is structured and configured for providing a user of said hearing device with speech sound by
A) providing in said hearing device speech-representing data representative of speech-bound contents, which speech-bound contents are encoded in said speech-representing data in a compressed way by means of a set of encoded-speech-segment data, each of said encoded-speech-segment data of said set being indicative of one speech segment, said speech-representing data comprising a multitude of said encoded-speech-segment data;
B) deriving from said multitude of said encoded-speech-segment data audio signals representative of said speech-bound contents by composing audio signal segments derived by decoding said multitude of encoded-speech-segment data; and
C) converting the so-derived audio signals into speech sound by means of an output converter of said hearing device.

In another embodiment, the hearing device comprises
B′) a converting unit structured and configured for deriving—from a multitude of encoded-speech-segment data, which multitude of encoded-speech-segment data is comprised in speech-representing data representative of speech-bound contents, said speech-bound contents being encoded in said speech-representing data in a compressed way by means of a set of encoded-speech-segment data, each of said encoded-speech-segment data of said set being indicative of one speech segment—audio signals representative of said speech-bound contents by composing audio signal segments derived by decoding said multitude of encoded-speech-segment data; and
C′) an output transducer structured and configured for converting said audio signals representative of said speech-bound contents into speech sound.

Besides the speech-related and other before-mentioned aspects, there are further ways of using MIDI in a hearing device. E.g., it is possible to listen to music (pop, classic or others) encoded in MIDI with the hearing device.

A hearing device comprising a sound generator could interpret MIDI data loaded into the hearing device and generate the corresponding music thereupon. Various musical pieces and works are today already available in form of MIDI data. Music could thus be generated within the hearing device and played to the hearing device user without the need for external sound generators like Hifi consoles or music synthesizers plus amplifiers. The MIDI DLS standard could be used here to achieve a particularly good and realistic audio reproduction.

In several of the above-described embodiments, the hearing device can be considered to comprise a converter for converting MIDI data into audio signals to be perceived (usually after an electro-mechanical conversion) by the hearing device user. Such a converter can be or comprise a signal processor, e.g., a digital signal processor (DSP), the converter can be or comprise a controller plus a sound generator or a controller plus a DSP. Also a sound memory may be comprised in the converter.

The hearing device is typically an ear level device. It may be worn partially or in full in or near the user's ear, or it may fully or in part be implemented, e.g., like a cochlea implant.

A hearing system according to the invention comprises a hearing device according to the invention. It may comprise one or more external microphones, a remote control or other accessories.

In one aspect, a method of operating a hearing device comprises at least one of the following steps:
communicating MIDI data;
loading MIDI data;
storing MIDI data;
interpreting MIDI data;
generating MIDI data;
   wherein MIDI stands for Musical Instrument Digital Interface.

In one embodiment, the method comprises the step of generating sound in said hearing device based on said interpretation of said MIDI data.

The advantages of the methods correspond to advantages of corresponding hearing devices and vice versa.

Further preferred embodiments and advantages emerge from the dependent claims and the figures.

### BRIEF DESCRIPTION OF THE DRAWINGS

Below, the invention is illustrated in more detail by means of embodiments of the invention and the included drawings.

The figures show:

FIG. 1 a block diagram of a first hearing device;

FIG. 2 a block diagram of a second hearing device;

FIG. 3 a block diagram of a third hearing device, emphasizing speech-related aspects;

FIG. 4 a diagram illustrating a speech-related method;

FIG. 5 a diagram illustrating a speech-related method;

FIG. 6 a diagram illustrating a speech-related method;

FIG. 7 a diagram illustrating a speech-related method;

FIG. 8 a diagram illustrating a speech-related method;

FIG. 9 a diagram illustrating a speech-related method;

FIG. 10 a diagram illustrating a speech-related method;

FIG. 11 a diagram illustrating a speech-related method;

FIG. 12 a diagram illustrating a speech-related method;

FIG. 13 a diagram illustrating a speech-related method;

FIG. 14 a diagram illustrating a speech-related method;

FIG. 15 a diagram illustrating a speech-related method.

The reference symbols used in the figures and their meaning are summarized in the list of reference symbols. The described embodiments are meant as examples and shall not confine the invention.

### DETAILED DESCRIPTION OF THE INVENTION

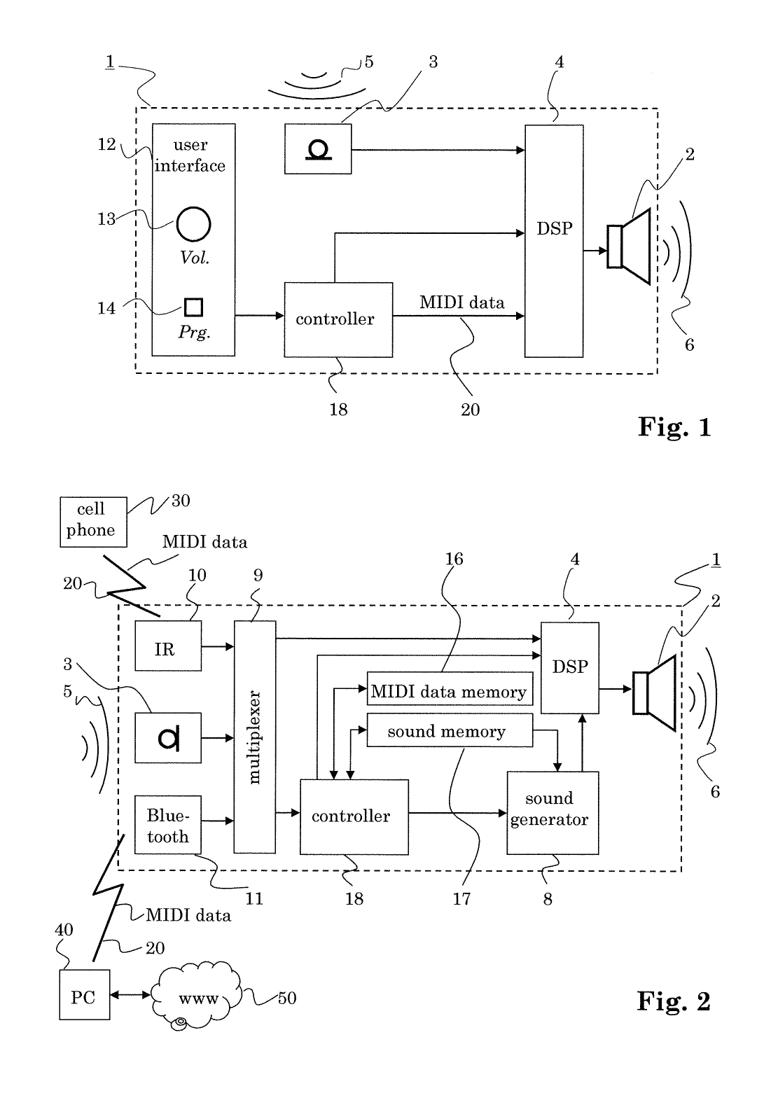

FIG. 1 shows a block diagram of a hearing device 1, e.g., a hearing aid, a hearing protection device, a communication device or the like. It comprises an input transducer 3, e.g., as indicated in FIG. 1, a microphone for converting incoming sound 5 into an electrical signal, which is fed into a signal processor 4, in which the signal can be processed and amplified. It is, of course, possible to provide a telephone coil as an input transducer. An amplification may take place in a separate amplifier. The processed amplified signal is then, in an output transducer 2, converted into a signal 6 to be perceived by the user of the hearing device. When, e.g., the transducer 2 is a loudspeaker, the signal 6 is an acoustical wave. In case of an implanted device 1, the signal 6 can be an electrical signal.

The device 1 of FIG. 1 furthermore comprises a user interface 12, through which the hearing device user may communicate with the hearing device 1. It may comprise a volume wheel 13 and a program change button 14. A controller 18, which controls said signal processor (DSP) 4, can receive input from said user interface 12. Said controller 18 can communicate with the signal processor via MIDI data 20. For example, a sound signal to be played to the user when the user selects a certain program (via said program change button 14), can be encoded in such MIDI data 20. The DSP 4 can function as a converter for converting MIDI data 20 into sound, that sound is to be perceived by the user after it has been converted in output transducer 2. For example, the MIDI data 20 instruct the DSP 4 to play a certain melody by passing to the DSP 4 the information, which sound wave to use, and for which duration and at which volume (loudness) to generate sound at which pitch. Also other instructions to the DSP 4 can be encoded in the MIDI data 20.

The embodiment of FIG. 1 exemplifies a rather internal use of MIDI data within a hearing device.

FIG. 2 shows a hearing device 1, which can communicate MIDI data 20 with external devices. In addition to an input transducer 3, the hearing device 1 comprises an infrared interface 10 and a bluetooth interface 11 for receiving external input and possibly send output, e.g., MIDI data, to an external device. Bluetooth is a well-known wireless standard in computing and mobile communication. Other interfaces, e.g., a radio frequency/FM interface, may be provided, and some interfaces may be embodied as an add-on to the hearing device. A multiplexer 9 is provided for selecting, which signals to forward to a DSP 4 and a contoller 18, respectively. A user interface 12 like the one in the embodiment of FIG. 1 may also be provided.

The hearing device 1 can receive MIDI data 20, as indicated in FIG. 2 from a mobile phone 30, from a computer, or from another device via said infrared interface 10. The hearing device 1 can receive MIDI data 20, as indicated in FIG. 2 from a computer 40, from a mobile phone, or from another device via said Bluetooth interface 11. The computer may be adapted to be connected to the world wide web 50, from where suitable MIDI data could be loaded into the computer and then communicated to the hearing device 1.

Of course, besides wireless connections, the hearing device 1 may also have the possibility to have a wire-bound connection for communicating with external or added-on devices.

The controller 18 not only gives instructions to the DSP 4, but has associated a MIDI data memory 16 for storing MIDI data 20, and a sound memory 17, in which sound data like digitally sampled sounds can be stored. A sound generator 8 is provided, which is controlled by controller 18 and can access said sound memory 17. In the DSP 4, sound generated by the sound generator 8 can be processed and, after amplification, fed to the output transducer 2.

The MIDI data memory 16 may store externally-loaded MIDI data or MIDI data generated in the hearing device 1. The sound memory 17 may store externally-loaded sounds, e.g., loaded via MIDI DownLoadable Sounds (DLS) data, or may store pre-programmed sounds (pre-stored sounds). The memories 16 and 17 can, of course be realized in one single memory and/or be integrated, e.g., in the controller 18.

The arrows indicating the interconnection of the various parts of the hearing devices in FIGS. 1 and 2 may partially be realized as bidirectional interconnections, even if in FIGS. 1 and/or 2 the corresponding arrow may only be unidirectional.

One of many ways to make use of MIDI data 20 in the hearing device 1 may be to load via one of the interfaces 10,11 MIDI data describing a telephone ring tone and store the MIDI data in the MIDI data memory 16 and recall said MIDI data when the mobile phone 30 informs the hearing device 1 that a telephone call is arriving. The ring tone (music and possibly also sound) encoded in the MIDI data is thereupon played to the hearing device user by the sound generator 8 via the DSP 4 and the transducer 2.

Another use of MIDI data 20 in the hearing device 20 is to receive via one of the interfaces 10,11 from, e.g., the computer 40, MIDI data, which describe a piece of music the user wants to listen to. The sound memory 17 may contain (pre-stored) sounds according to the General MIDI standard (GM). The controller 18 instructs the sound generator to generate notes according to the MIDI data 20 with sounds from the sound memory 17 having the General MIDI sound number given in the MIDI data 20. This way, musical pieces can be generated, according to loaded MIDI instructions, fully within the hearing device 1. Of course, it is also possible to load all MIDI data for the piece of music first, store them in the MIDI data memory 16, and play them later, e.g., upon a start signal provided by the user through a user interface, like the user interface 12 in FIG. 1.

Another use of MIDI data 20 in the hearing device 20 is to load via one of the interfaces 10,11 MIDI data 20, which contain speech sounds, e.g., when the MIDI data 20 are MIDI DLS data. For example, to different (musical) keys (C4, C#4, . . . ) a sampled sound of different vowels and consonants can be assigned, or even syllables, full words or sentences. By means of sounds of such a sound set, the user could be informed about the status of a hearing device's battery or about some user manipulation of a user interface or the like in form of speech messages like “battery is low, please insert a new battery soon” or “volume is adjusted to 8”. The text would be encoded in sequences of musical keys, with durations, loudness volumes and so on, just like a piece of music, in MIDI data.

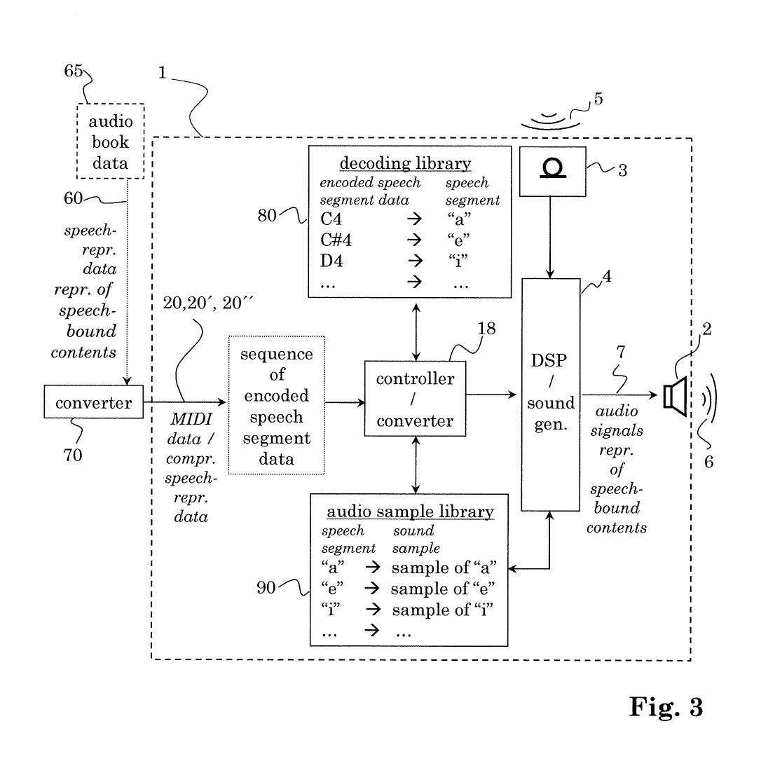

FIG. 3 shows a block diagram of a third hearing device, emphasizing speech-related aspects. Due to the very limited storage space and the limited processing power in a hearing device, it is suggested to deal with speech-bound contents by using compressed data, as already noted before. This is also recommendable because of the limited energy resources available in a hearing device, since this results in a limited bandwidth for wireless communication to (and from) a hearing device. In particular it is possible to transfer speech-bound contents to (or from) a hearing device using speech-representing data in which the speech-bound contents is encoded in a compressed way, in particular by means of a set of encoded-speech-segment data, e.g., each of said encoded-speech-segment data of said set being indicative of one speech segment such as a phoneme. Further details and possibilities of dealing with speech-related data have already been pointed out in the above section “Summary of the Invention”. As pointed out before, MIDI data is a good example for such compressed speech-representing data, but other ways of compression using speech segments are nevertheless possible.

In FIG. 3, hearing device 1 is provided with compressed speech-representing data 20′ such as MIDI data 20, more particularly with a sequence 20″ of encoded-speech-segment data. E.g., these data are transferred to and into hearing device 1 from an external device which external device can be a device of a hearing system to which the hearing device 1 belongs or a device external to such a hearing system. The transmission of the data can be accomplished, e.g., via a wireless link.

The data are obtained by means of a converter 70 such as an encoder fed with uncompressed or differently compressed data 60, wherein data 60 are speech-representative data representative of speech-bound contents such as audio book data stored in a storage element 65 such as an audio book CD. Data 60 may be, e.g., uncompressed or compressed (e.g., MP3) data representing sound, or text data such as ASCII text.

In hearing device 1, the sequence 20″ of encoded-speech-segment data is inputted to a controller 18 such as a converter which interacts with DSP 4 and one or more libraries in order to obtain from the sequence 20″ of encoded-speech-segment data audio signals 7 representative of the speech-bound contents, more particularly in the case depicted in FIG. 1 representative of the contents of the before-addressed audio book.

Although in practice, usually only one data library will be used, in FIG. 1, two data libraries 80 and 90, respectively, are shown, in order to more clearly illustrate some of the terms used in conjunction with speech encoding.

By the received stream of MIDI data 20, controller 18 will receive encoded-speech-segment data such as MIDI data indicative of playing a certain note such as playing the note C4. By means of decoding library 80, this information is converted into the information indicative of the respective speech segment, e.g., the phoneme “a” as in the word “hat” (or a specific syllable such as “ment” or a specific word). By means of audio sample library 90, the speech segment (“a”) is associated with a respective (usually digital) sound sample, i.e. with data obtained by (digitally) recording the sound of the letter “a” as in the word “hat”, i.e. with data representative of the sound of the letter “a” as in the word “hat”. Instead of this two-step conversion via libraries 80 and 90, a one-step conversion could be employed using a library directly associating encoded-speech-segment data with the respective sound samples.

By means of digital signal processor 4, the so-obtained sound samples are composed, thus deriving a sequence of sound samples, which constitutes the sought audio signals 7 representative of the speech-bound contents of the before-addressed audio book. Audio signals 7 are then converted into signals to be perceived by the user of the hearing device 1, such that sound waves 6 obtained using output transducer 2 of hearing device 1 such as a receiver (loudspeaker), wherein this output transducer 2 of hearing device 1 is the same output transducer as employed during the “normal” use of hearing device 1 in which sound is picked up by in input transducer 3 of hearing device 1 such as a microphone and converted into audio signals which are then processed in signal processor 4 and then outputted by means of output transducer 2.

Instead of a sample-based way of generating audio signals 7, it is also possible to synthesize these in other ways, e.g., using a speech synthesizer. In this case, instead of a audio sample library 90, a library would be provided and used which associates with each speech segment appropriate sound generating data such as data indicating an appropriate pitch, appropriate frequency contents such as formants and the like and appropriate time durations.

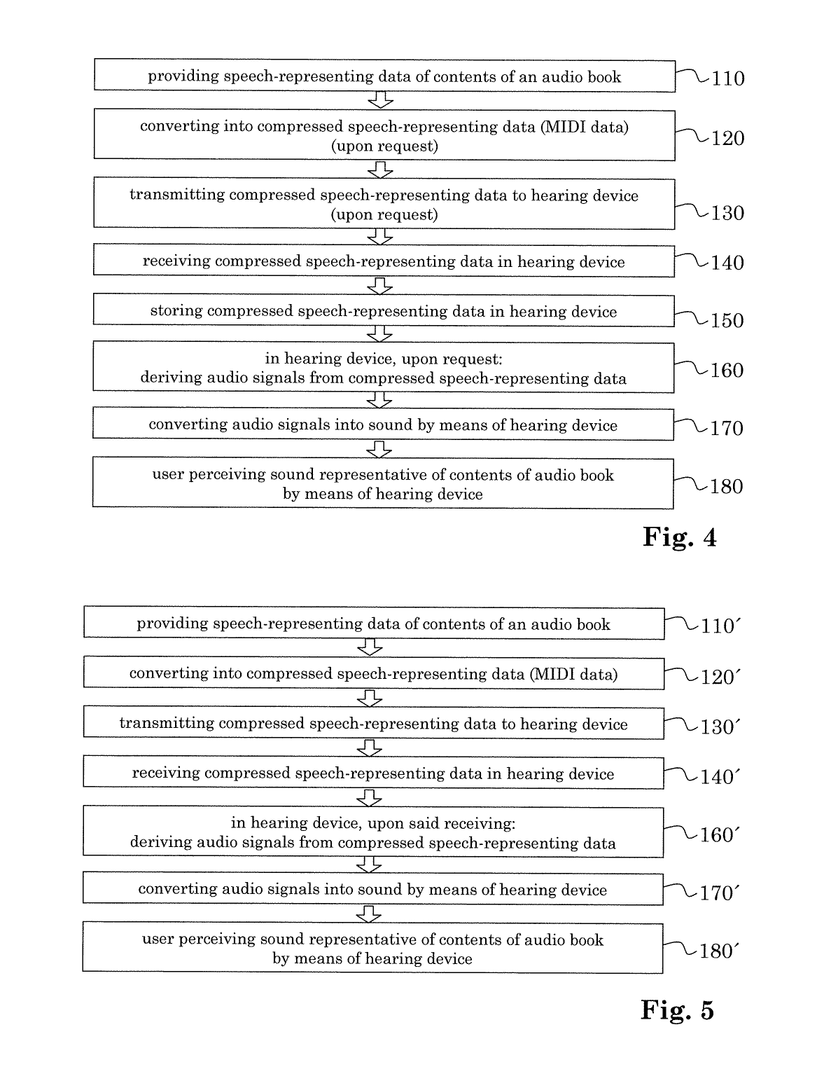

Below, several specific applications will be discussed by means of FIGS. 4 to 16 in which diagrams are shown illustrating various speech-related methods. Some of them are “live-stream”-like applications in which the sequence 20″ (or stream) of encoded-speech segment data is converted into the audio signals 7 upon their receipt, i.e., close in time to their reception. Others are “offline”-like applications in which the sequence 20″ (or stream) of encoded-speech segment data is stored in hearing device 1 upon their receipt (as symbolized by the dotted rectangle in FIG. 1) in order to be recalled and converted at a later time unrelated to the time of their reception.

In FIG. 4 is depicted an offline-like method for listening to audio book contents by means of a hearing device. In step 110, speech-representing data representative of the contents of an audio book are provided (cf. references 60 and 65 in FIG. 3). These are, usually upon request of the hearing device user, converted into compressed speech-representing data in step 120 (cf. also reference 70 in FIG. 3). In step 130, these are transmitted into the hearing device, e.g., in a wireless (or in a wirebound) fashion, usually upon the same or upon another request by the user. In step 140, the data are received in the hearing device, and then, in step 150, stored therein.

Upon another user request, audio signals (cf. reference 7 in FIG. 3) are obtained in the hearing device from the stored compressed speech-representing data in step 160 (cf. references 4, 18, 80, 90 in FIG. 3) and thereupon, these audio signals are in step 170 converted into sound perceived by the user (step 180) (cf. references 2 and 6 in FIG. 3).

All this can be accomplished using a rather small bandwith for transmitting data to the hearing device and with very low storage space requirements in the hearing device.

In the other embodiments described below, the relation of method steps and the embodiment of FIG. 3 mostly is the same as or similar to what has been described in conjunction with FIG. 4; the method steps of the embodiments below are readily related to the steps of the embodiment of FIG. 4.

In FIG. 5 is depicted a “live-stream”-like method for listening to audio book contents by means of a hearing device. Most steps are similar or equal to corresponding steps in FIG. 4, but storing of the whole sequence of compressed audio-representing data is required (step 150 in FIG. 4), and in step 160′, the audio signals are derived upon step 140′, usually not requiring another user request.

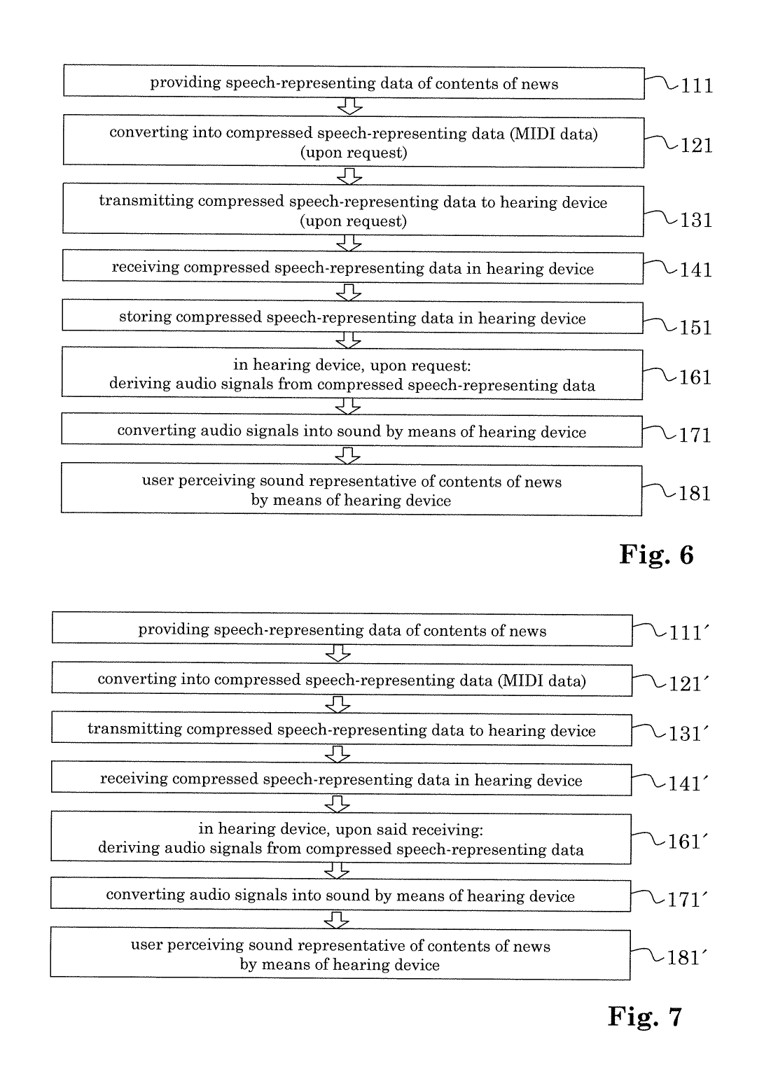

The embodiments of FIGS. 6 and 7 are similar to the embodiments of FIGS. 4 and 5, respectively. But instead of relating to an audio book, these methods relate to news, more particularly to methods for listening to contents of news by means of a hearing device.

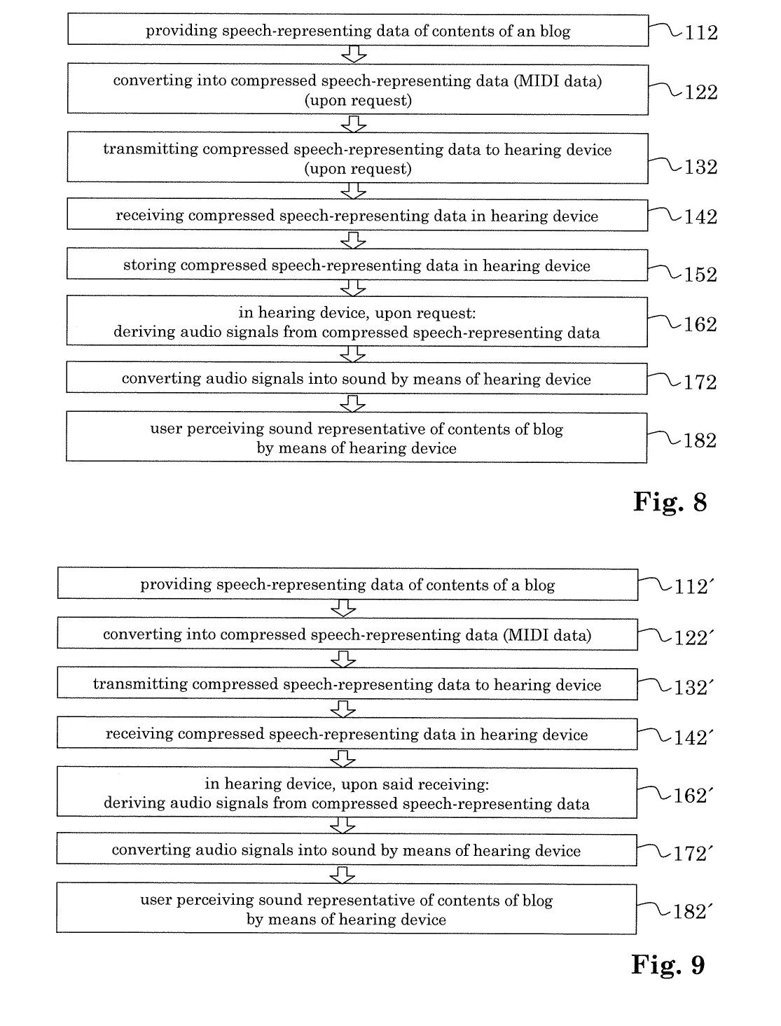

The embodiments of FIGS. 8 and 9 are similar to the embodiments of FIGS. 4 and 5, respectively. But instead of relating to an audio book, these methods relate to a blog or to blogs, more particularly to methods for listening to contents of blogs by means of a hearing device. In this case, the source of the speech-representing data (cf. reference 60 in FIG. 3) will usually be the internet.

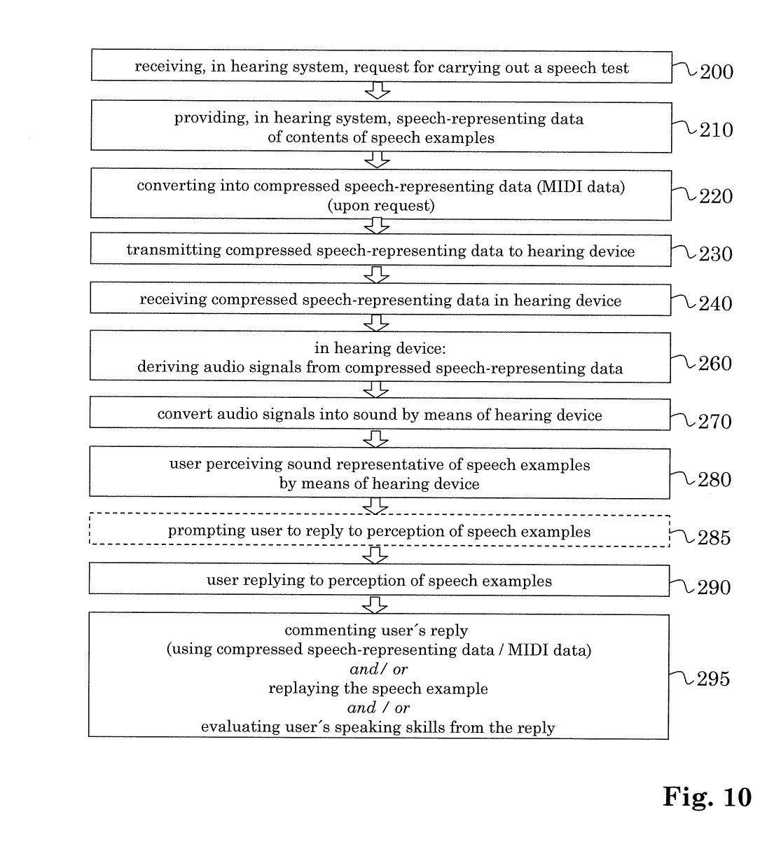

In FIG. 10 a method is depicted for carrying out a speech test by means of a hearing device, and more particularly details for generating in a hearing device speech examples for a speech test. In step 200, in a hearing system comprising the hearing device, a user request for carrying out a speech test is received. In step 210, speech-representing data of the contents of speech examples are provided in the hearing system. In step 220, these are converted into compressed speech-representing data, either upon the same user request or usually upon another user request. Steps 200, 210 and 220 usually take place in a device of the hearing system different from the hearing device.

In step 230, the compressed speech-representing data are transmitted to the hearing device, and in step 240, they are received in the hearing device. Steps 230 and 240 are optional, but usually, they are carried out. In steps 260 to 280, audio signals are derived and converted into sound, and the user perceives the sound.

In step 290, the user replies to the perception of the speech examples, optionally after being prompted for a reply (step 285).

In step 295, several possible optional further steps are addressed.

A comment regarding the user's reply can be made, e.g., using compressed speech-representing data, e.g., in a way similar to what has been depicted above. E.g., an indication could be given to the user that his pronounciation of a word or sentence was good (e.g., as judged from audio signals picked up by the hearing device's microphones, cf. reference 3 in FIG. 3), e.g., by producing a high-pitched beep or by providing the user with speech sound saying “Well done!”.

And/or the before-presented speech example can be presented to the user once more, e.g., in case the user's pronounciation has been considered insufficient.

And/or the user's speaking skills are evaluated from the user's reply, e.g., as described above by judging audio signals picked up by the hearing device's microphones of the user's reply.

The depicted method allows to make a speech test in a particularly memory space saving way (in the hearing device) and requiring only a relatively small bandwidth for communicating to the hearing device.

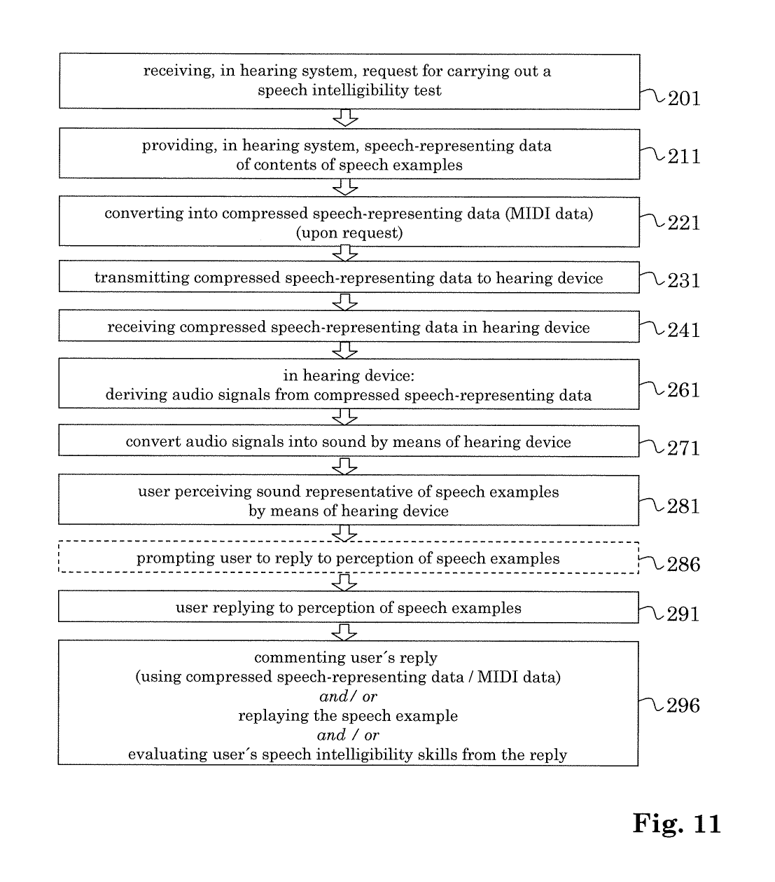

The embodiment of FIG. 11 is similar to the embodiment of FIG. 10. But instead of relating to a speech test, this method relates to a speech intelligibility test.

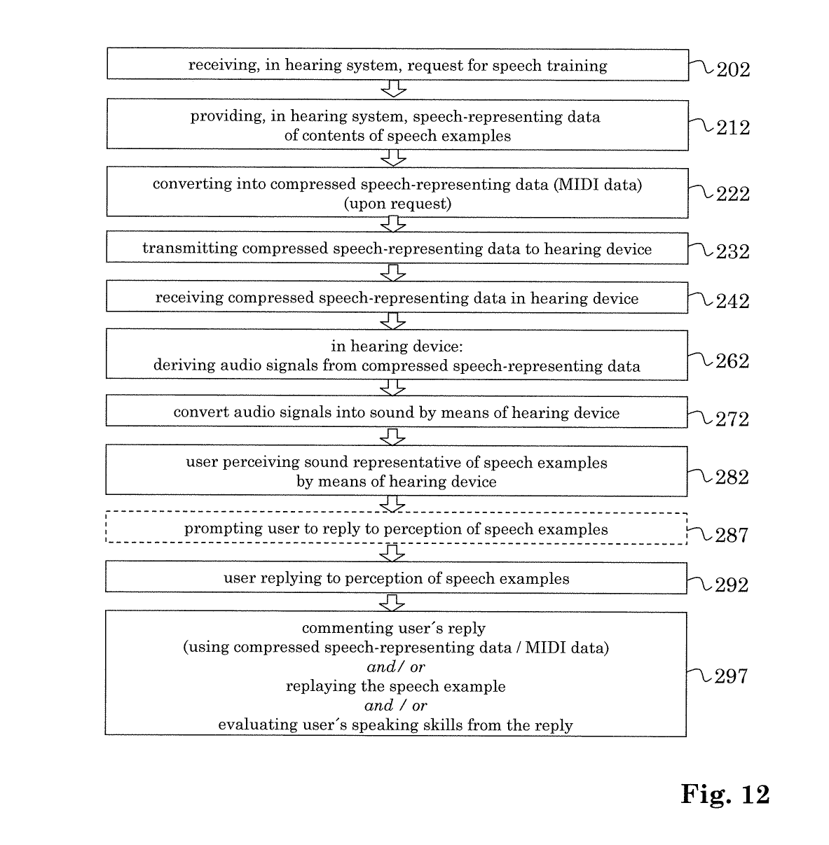

The embodiment of FIG. 12 is similar to the embodiment of FIG. 10. But instead of relating to a speech test, this method relates to a speech training.

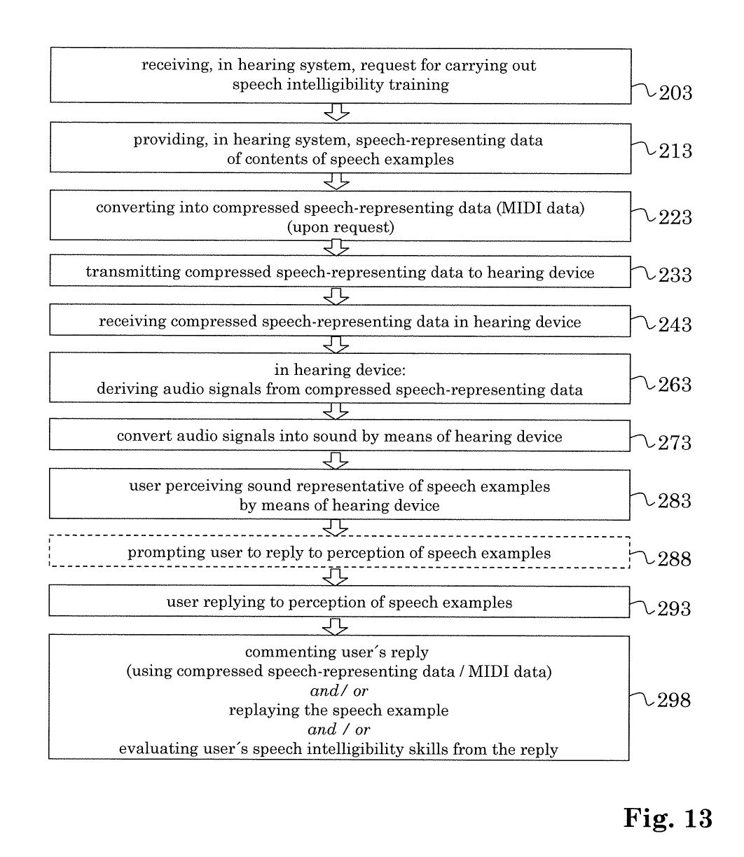

The embodiment of FIG. 13 is similar to the embodiment of FIG. 10. But instead of relating to a speech test, this method relates to a speech intelligibility training.

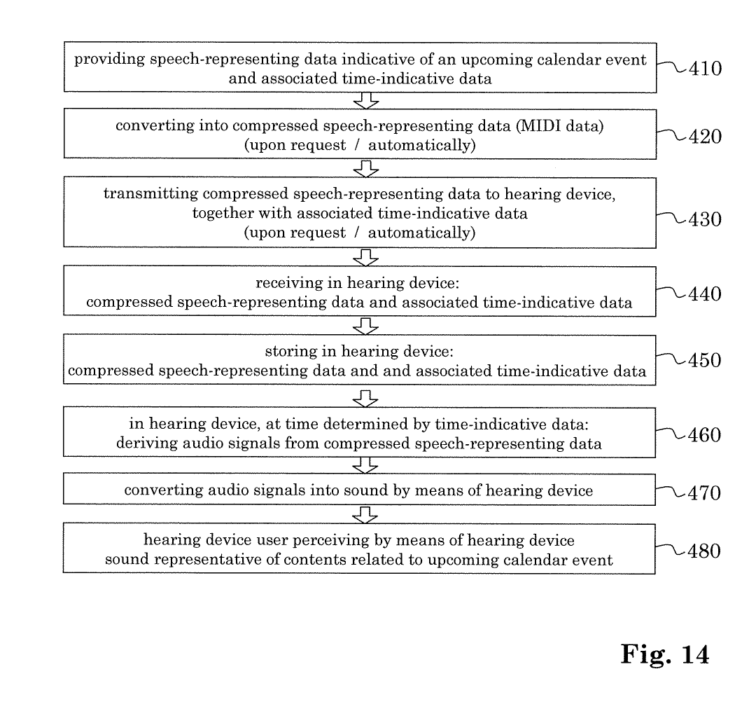

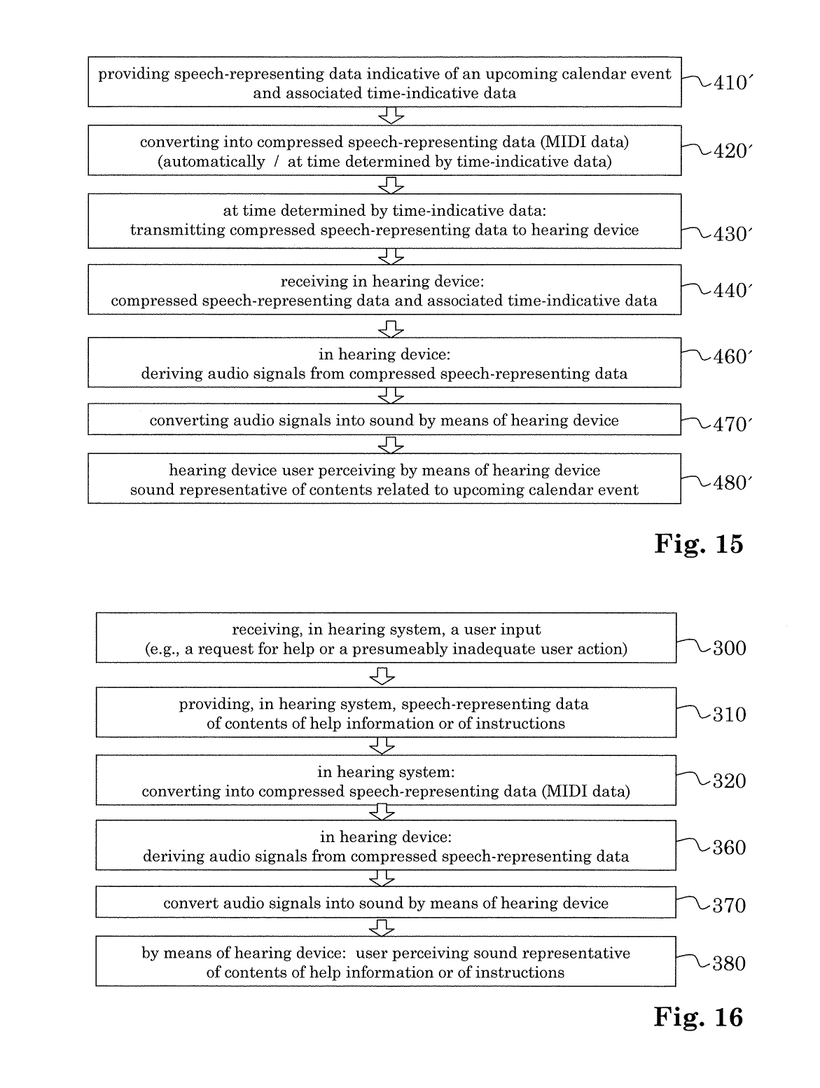

In FIGS. 14 and 15 are depicted methods for providing a hearing device user with information about upcoming calendar events by means of the hearing device, and more particularly details for generating in a hearing device sound representing information about upcoming calendar events. In FIG. 14, an “offline”-type of method is illustrated, whereas in FIG. 15, a “live-stream”-like method is illustrated.

FIG. 14: In step 410, speech-representing data of one or more upcoming calendar events are provided, together with respective associated time-indicative data. E.g., the speech-representing data are indicative of “Please take your blood pressure medicine now”, and the associated time-indicative data are indicative of “Apr. 12, 2010, 8:00 a.m.” or of “everyday, 8:00 a.m.”.

In step 420, the speech-representing data are automatically or upon a user request converted into compressed speech-representing data such as MIDI data. Steps 410 and 420 can be carried out in a device (or several devices) comprised in the hearing system or external to the hearing system. In step 430, the data are transmitted to the hearing device, together with the associated time-indicative data; in step 440, they are stored in the hearing device (together with the associated time-indicative data).

At a time determined by the time-indicative data, e.g., at the indicated time or five minutes in advance or so, audio signals are derived from the compressed audio-representing data/MIDI data (step 460). Thereupon, in step 470, these audio signals are converted into sound by means of the hearing device, and the user is informed (at the appropriate time) of the upcoming calendar event (step 480).

For example, once every day or once or twice a week, data are transferred into the hearing device (and possibly synchronized with the external device such as a computer, e.g., in the way well-known from synchronisation between a computer and a PDA). And for each event, the user will be, at the appropriate time, informed by speech sound explaining the calendar event.

The embodiment of FIG. 15 differs from the one of FIG. 14 mainly in that it is not necessary to store the whole sequence of compressed speech-representing data (cf. step 450 in FIG. 14) and in that it is not necessary to transmit the time-indicative data to the hearing device, and that steps 460′ to 480′ take place upon step 440′, not requiring a user input.

In FIG. 16 a method is depicted for providing a hearing device user with help information about operating the hearing device and/or with instructions about operating the hearing device. The method will usually start with receiving a user input in the hearing system (step 300). This user input can be, e.g., an explicit request of the user for help or for instructions, but it is also possible that the user input indicates that it would be advisable to provide the user with instructions or help information because the user input seems inappropriate.

In response to step 300, in step 310 speech-representing data representative of suitable help information or instructions are provided in the hearing system. These are converted into a compressed form in step 320. In steps 360 to 380, respectively, from these data audio signals are derived which are then converted into sound perceived by the user.

With respect to steps 310 and 320 (and possibly also step 300), it is possible to have these carried out externally to the hearing device. But it is also possible to provide, in the hearing device, already the compressed audio-representing data (a conversion into the compressed form may have taken place at some other place at some time earlier, unrelated to the time at which step 300 takes place). This way, the whole method can be carried out even with only the hearing device alone.

Many further useful uses of MIDI data in a hearing device are possible.

Aspects of the embodiments have been described in terms of functional units. As is readily understood, these functional units may be realized in virtually any number of hardware and/or software components adapted to performing the specified functions. For example, units 80 and 90 could be realized in one and the same memory element; and signal processor 4 and controller 18 can be realized in one and the same chip.

### LIST OF REFERENCE SYMBOLS

1 hearing device
2 transducer, output transducer, loudspeaker, receiver
3 transducer, input transducer, microphone
4 signal processor, digital signal processor, DSP
5 sound, incoming sound, incoming audio signal
6 signals to be perceived by the user, sound, outgoing sound, speech sound
7 audio signals, audio signals representative of speech-bound contents
8 sound generator
9 multiplexer
10 infrared interface
11 Bluetooth interface
12 user interface, set of controls
13 control, volume wheel
14 control, program change knob
16 MIDI data memory
17 sound memory
18 controller, processor chip
20 MIDI data, MIDI file, MIDI message
20′ encoded-speech-representing data (compressed), compressed speech-representing data
20″ sequence of encoded-speech-segment data
30 cellular phone, mobile phone
40 computer, personal computer
50 worldwide web, www
60 speech-representative data, speech-representative data representative of speech-bound contents (uncompressed, unencoded, differently compressed)
65 storage element, memory element, harddisk, CD, DVD
70 converter, encoder
80 data, decoding library
90 data, audio sample library

1. A method for providing a user of a hearing device with speech sound, comprising the steps of
a) providing in said hearing device speech-representing data representative of speech-bound contents, which speech-bound contents are encoded in said speech-representing data in a compressed way by means of a set of encoded-speech-segment data, each of said encoded-speech-segment data of said set being indicative of one speech segment, said speech-representing data comprising a multitude of said encoded-speech-segment data;
b) deriving from said multitude of said encoded-speech-segment data audio signals representative of said speech-bound contents by composing audio signal segments derived by decoding said multitude of encoded-speech-segment data; and
c) converting the so-derived audio signals into speech sound by means of an output converter of said hearing device.

2. The method according to claim 1, wherein said speech-representing data are digital data, and said set of encoded-speech-segment data is a pre-defined set of a pre-defined number of encoded-speech-segment data, and wherein speech is composable from said speech segments.

3. The method according to claim 1 or claim 2, wherein said hearing device is a device, which is worn in or adjacent to an individual's ear with the object to improve the individual's audiological perception, wherein such improvement may also be barring acoustic signals from being perceived in the sense of hearing protection for the individual.

4. The method according to one of the preceding claims, comprising, before step a) the step of
r) receiving in said hearing device said speech-representing data.

5. The method according to claim 4, comprising, before step r), the steps of
d) generating said speech-representing data in a device different from said hearing device; and
e) transmitting said speech-representing data from said device to said hearing device.

6. The method according to one of the preceding claims, wherein said encoded-speech-segment data are MIDI data.

7. The method according to one of the preceding claims, wherein step b) comprises the steps of
b1) deriving, for each of said encoded-speech-segment data of said multitude of said encoded-speech-segment data, an audio signal segment representative of the respective speech segment;
b2) deriving audio signals representative of said speech-bound contents by composing the so-derived audio signal segments.

8. The method according to one of the preceding claims, wherein said method is a method for speech training or for speech intelligibility training or for speech testing or for speech intelligibility testing.

9. The method according to claim 8, comprising the step of
f) prompting said user for a reply in reaction to perceiving said speech sound outputted in step c).

10. The method according to claim 9, comprising the steps of
g) receiving a reply from said user in reply to said prompting mentioned in step f);
h) evaluating said reply; and
i) taking an action in dependence of a result of said evaluation.

11. The method according to one of the preceding claims, said speech-bound contents being help information for said user or instructions for said user.

12. The method according to claim 11, wherein step c) is carried out upon a request by said user, and step b) is carried out upon a request by said user.

13. The method according to one of the preceding claims, said speech-bound contents being or comprising information about one or more upcoming calendar events.

14. The method according to claim 13, comprising, before step a), the step of
r) receiving in said hearing device said speech-representing data.

15. The method according to claim 14, wherein the time at which said conversion mentioned in step c) is carried out depends on time-indicative data associated with said one or more upcoming calendar events encoded in said speech-representing data.

16. The method according to claim 14 or claim 15, wherein said steps a), b) and c) are carried out upon step r).

17. The method according to claim 13 or claim 14, comprising the step of
s) receiving in said hearing device time-indicative data associated with said one or more upcoming calendar events encoded in said speech-representing data;
wherein said step r) is accomplished at a time before a time indicated by said time-indicative data and otherwise independent of said time indicated in said time-indicative data.

18. The method according to one of claims 13 to 17, comprising, before step a), the step of
r) receiving in said hearing device said speech-representing data;
wherein step r) is carried out upon a request by said user.

19. The method according to one of the preceding claims, said speech-bound contents being contents of an audio book or news or contents of a blog.

20. The method according to claim 19, comprising, before step a) the step of
r) receiving in said hearing device said speech-representing data.

21. The method according to claim 20, wherein said steps a), b) and c) are carried out upon step r).

22. The method according to claim 20, wherein the time at which said conversion mentioned in step c) is carried out is not determined by said speech-bound contents.

23. The method according to one of the preceding claims, wherein said hearing device is at least one of a hearing aid and a hearing protection device

24. A hearing device structured and configured for providing a user of said hearing device with speech sound by
A) providing in said hearing device speech-representing data representative of speech-bound contents, which speech-bound contents is encoded in said speech-representing data in a compressed way by means of a set of encoded-speech-segment data, each of said encoded-speech-segment data of said set being indicative of one speech segment, said speech-representing data comprising a multitude of said encoded-speech-segment data;
B) deriving from said multitude of said encoded-speech-segment data audio signals representative of said speech-bound contents by composing audio signal segments derived by decoding said multitude of encoded-speech-segment data; and
C) converting the so-derived audio signals into speech sound by means of an output converter of said hearing device.

25. A hearing device comprising
B′) a converting unit structured and configured for deriving—from a multitude of encoded-speech-segment data, which multitude of encoded-speech-segment data is comprised in speech-representing data representative of speech-bound contents, said speech-bound contents being encoded in said speech-representing data in a compressed way by means of a set of encoded-speech-segment data, each of said encoded-speech-segment data of said set being indicative of one speech segment—audio signals representative of said speech-bound contents by composing audio signal segments derived by decoding said multitude of encoded-speech-segment data; and
C′) an output transducer structured and configured for converting said audio signals representative of said speech-bound contents into speech sound.
